(19) United States
(12) Patent Application Publication
(10) Pub. No.: US 2006/0255920 A1
(43) Pub. Date: Nov. 16, 2006

(54) Annunciating device for vehicle

(75) Inventors: Toshiro Maeda, Anjo-shi (JP); Takashi Okada, Kariya-shi (JP); Koji Aoki, Nagoya-shi (JP); Takashi Hiramaki, Nagoya-shi (JP)

Correspondence Address: BUCHANAN, INGERSOLL & ROONEY PC, POST OFFICE BOX 1404, ALEXANDRIA, VA, 22313-1404, US

(73) Assignee: Aisin Seiki Kabushiki Kaisha, Kariya-shi (JP)

(21) Appl. No.: 11/430,947

(22) Filed: May 10, 2006

(30) Foreign Application Priority Data
May 10, 2005 (JP) 2005-136966
Nov. 10, 2005 (JP) 2005-326450

(51) Int. Cl. H04B 3/36

(52) U.S. Cl. 340/407.1; 340/438

(57) ABSTRACT

An annunciating device for a vehicle includes a seat, a pair of support frames provided at both sides of the seat and extending in a back and forth direction or in an up and down direction of the seat, and at least two vibration generators provided side by side at an interior part of the seat for generating a vibration by reciprocating a vibrator, an operation of one of the vibration generators or both of the vibration generators being controlled, wherein the vibrator reciprocates on an axis line which does not intersect with the support frame.

This application is based on and claims priority under 35 U.S.C. § 119 to Japanese Patent Applications 2005-136966, filed on May 10, 2005, and 2005-326450, filed on Nov. 10, 2005, the entire content of which is incorporated herein by reference.

### FIELD OF THE INVENTION

The present invention relates to an annunciating device for a vehicle, which alerts an occupant seated on a seat by means of an operation of a vibration generator. More particularly, the present invention pertains to an annunciating device for a vehicle, which informs an occupant on which side an unsafe condition exists outside or the vehicle.

### BACKGROUND

A known annunciating device for a vehicle is disclosed in JP2000225877A, which includes a seat provided in a vehicle compartment and to be seated by an occupant, support frames respectively provided at both sides of the seat for supporting the seat, and vibration generators provided side by side at an interior part of the seat for generating a vibration. The disclosed annunciating device informs the occupant on which side an unsafe condition exists outside of the vehicle by switching between a left side annunciation state in which the vibration generator placed at the left side of the seat is operated and a right side annunciation state in which the vibration generator placed at the right side of the seat is operated. The disclosed annunciating device is used, for example, for informing the occupant of an obstacle or an approaching vehicle at the time of driving on a local street or a highway or at the time of parking at a parking area.

According to the annunciating device disclosed in JP2000225877A, the vibration generator is adopted which generates the vibration by rotating a vibrator. This type of vibration generator includes a characteristic that a level of vibration vector in a rotational radial direction of the vibrator (i.e., a direction perpendicular to a rotational center) is at a higher degree.

However, according to the annunciating device disclosed in JP2000225877A, the vibration generators are arranged in such a manner that the rotational radial direction of the vibrator is directed toward the support frame as illustrated in FIG. 16. Therefore, the vibration transmitted to the support frame from the vibration generator may be increased and a sound may occasionally be generated because of the vibration of the support frame and the vibration of each component connected to the support frame.

Further, if the vibration generators are arranged as far away from the frame as possible in order to avoid generating sound, the vibration generators arranged side by side came close to each other. In consequence, the occupant may have difficulty to figure out from which side the vibration is being transmitted.

A need thus exists for an annunciating device, with which an occupant can clearly figure out from which side the vibration is transmitted while restricting the generation of a sound.

### SUMMARY OF THE INVENTION

According to an aspect of the present invention, an annunciating device for a vehicle includes a seat, a pair of support frames provided at both sides of the seat and extending in a back and forth direction or in an up and down direction of the seat, and at least two vibration generators provided side by side at an interior part of the seat for generating a vibration by reciprocating a vibrator, an operation of one of the vibration generators or both of the vibration generators being controlled, wherein the vibrator reciprocates on an axis line which does not intersect with the support frame.

According to another aspect of the present invention, an annunciating device for a vehicle includes a seat, a pair of support frames provided at both sides of the seat and extending in a back and forth direction or in an up and down direction of the seat, and at least two vibration generators provided side by side at an interior part of the seat for generating a vibration by rotary operating a vibrator, an operation of one of the vibration generators or both of the vibration generators being controlled, wherein a surface of the vibrator extending in a rotational radial direction thereof does not intersect with the support frame.

According to still another aspect of the present invention, an annunciating device for a vehicle includes a seat, a support frame provided at the seat and extending in a back and forth direction or in an up and down direction of the seat, and a vibration generator provided at an interior part of the seat for generating a vibration by reciprocating a vibrator or by rotary operating a vibrator, wherein a direction of a reciprocating operation of the vibrator or a surface of the vibrator extending in a rotational radial direction thereof does not intersect with the support frame.

### BRIEF DESCRIPTION OF THE DRAWINGS

The foregoing and additional features and characteristics of the present invention will become more apparent from the following detailed description considered with reference to the accompanying drawings, wherein:

FIG. 1 is a perspective view for schematically indicating a condition where an annunciating device according to a first embodiment of the present invention is mounted to a seat.

FIG. 2 is a sectional view of FIG. 1.

FIG. 3 is a side view for schematically indicating a condition where a driver is seated on the seat illustrated in FIG. 1.

FIG. 4 is a perspective view for schematically indicating a condition where an annunciating device according to a second embodiment of the present invention is mounted to a seat.

FIG. 5 is a perspective view indicating a vibration generator according to the second embodiment of the present invention.

FIG. 6 is a sectional view of FIG. 4.

FIG. 7 is a perspective view for schematically indicating an annunciating device according to a third embodiment of the present invention.

FIG. 8 is a sectional view of FIG. 7.

FIG. 9 is a perspective view for schematically indicating an annunciating device according to a fourth embodiment of the present invention.

FIG. 10 is a sectional view taken along line X-X of FIG. 9.

FIG. 11 is a perspective view for schematically indicating an annunciating device according to a fifth embodiment of the present invention.

FIG. 12 is a sectional view taken along line XII-XII of FIG. 11.

FIG. 13 is a plan view for schematically indicating an annunciating device according to a sixth embodiment of the present invention.

FIG. 14 is a diagram for schematically indicating an electrical structure of the annunciating device according to the sixth embodiment of the present invention.

FIG. 15 is a time chart indicating a stroke of the vehicle door at the time of a door opening operation.

FIG. 16 is a sectional view for schematically indicating an annunciating device according to a related art.

### DETAILED DESCRIPTION

Embodiments of the present invention will be explained hereinbelow with reference to the attached drawings. Back and forth, right and left, and up and down directions described in the specification are based on the directions of a vehicle or a seat. Further, arrows indicating back and forth, right and left, and up and down directions in the drawings are based on a condition where an annunciating device is mounted to a vehicle.

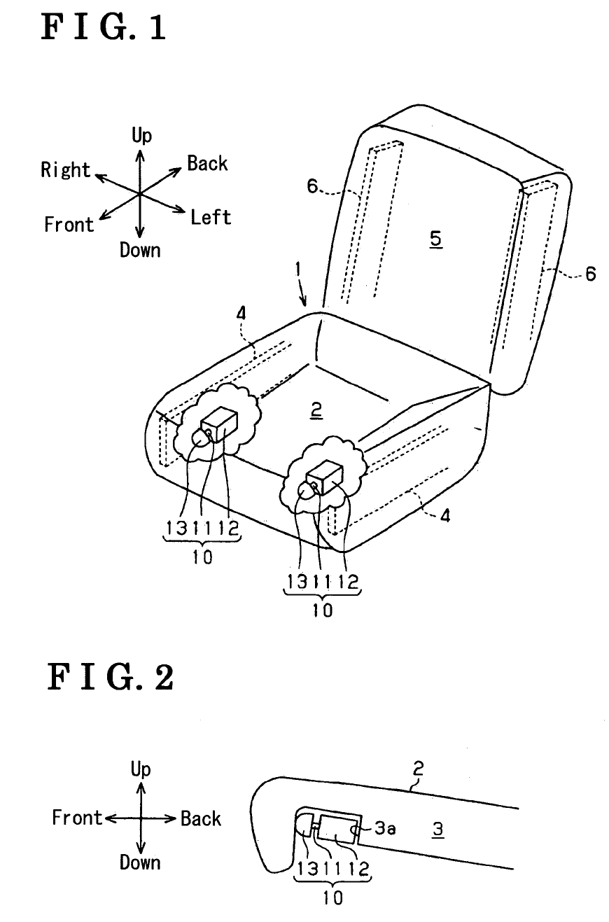

A first embodiment of the present invention is explained hereinafter with reference to FIGS. 1-3.

As illustrated in FIG. 1, an annunciating device includes a pair of vibration generators 10 provided side by side at an interior part of a seating portion 2 of a seat 1. Each vibration generator 10 includes an identical structure with each other. As illustrated in FIG. 2, the vibration generators 10 are arranged at a front portion of the seating portion 2. Further, a concave portion 3a is formed below a cushion member (e.g., polyurethane foam) 3 of the seat 1. The vibration generator 10 is inserted and placed at the concave portion 3c.

The vibration generator 10 serving as a linear type vibrating motor includes an electrical motor 12 (e.g., solenoid) for reciprocating a drive member 11 by means of electromagnetic power and a vibrator 13 assembled to an end portion of the drive member 11. Further, each vibration generator 10 is arranged in such a manner that a direction of a reciprocating movement of the electrical motor 12 is directed to the back and forth direction. Thereby, vibration generated by means of the vibration generator 10 is transmitted to the cushion member 3 to largely vibrate the cushion member 3 in the back and forth direction. Then, the vibration is transmitted to a driver from his/her thighs to buttocks through the cushion member 3.

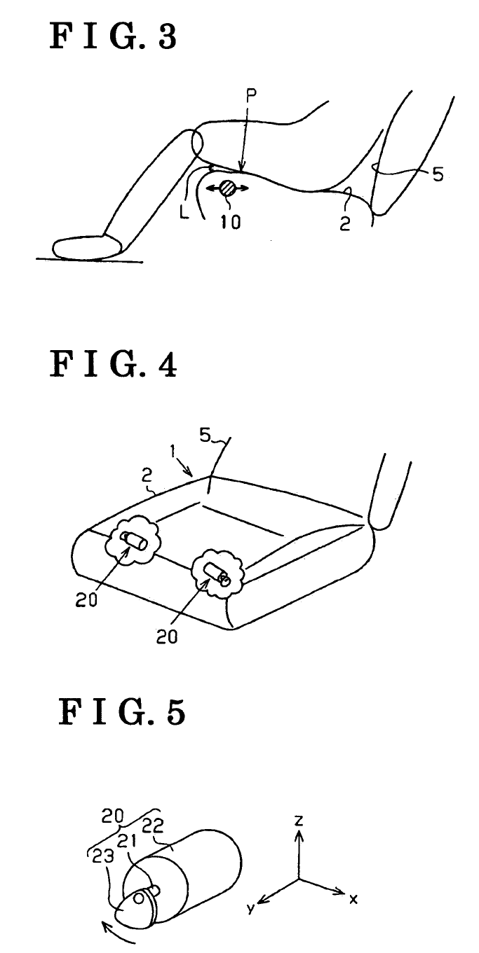

Depending on the seating posture of the driver, a part of the driver's thighs may be placed directly above the vibrator 13 but may not be in contact with a seating surface of the seat 1, and a space L may be left between the part of the driver's thighs and the seating surface of the seat 1 as illustrated in FIG. 3. In such a case, the vibration is transmitted to the driver through a part (indicated as P) of the driver's thighs which are in contact with the seating surface.

Numeral 4 in FIG. 1 indicates a pair of cushion frames (i.e., first support frames) provided at both sides of the seating portion 2 and extending in the back and forth direction. The pair of cushion frames 4 for supporting the seating portion 2 of the seat 1 is provided with an upper rail (not shown) and is slidably assembled to a lower rail fixed to a floor of the vehicle. Further, numeral 5 in FIG. 1 indicates a seatback portion of the seat 1, and numeral 6 in FIG. 1 indicates a pair of seatback frames (i.e., second support frames) provided at both sides of the seatback portion 5 and extending in the up and down direction. Each seatback frame 6 for supporting the seatback portion 5 of the seat 1 is rotatably assembled to each cushion frame 4.

An example of an operation of the annunciating device for the vehicle is explained hereinafter. The annunciating device makes the occupant to feel a difference in level between the vibration from the vibration generator 10 placed at the left side and the vibration from the vibration generator 10 placed at the right side in a condition where an obstacle appears in front of the vehicle at the time of driving on a local street or a highway. Accordingly, the annunciating device is operated to inform the driver on which side an unsafe condition exists outside of the vehicle.

More particularly, if an existence of the obstacle is judged at a front right side of the vehicle by means of an analysis of an image by a photographing apparatus or by means of an obstacle detecting apparatus such as an infrared radiation sensor, or the like, a right side annunciation state is generated to inform the driver of the existence of the obstacle at the front right side of the vehicle by operating the vibration generator 10 placed at the right side while pausing an operation of the vibration generator 10 placed at the left side. In contrast, if an existence of an obstacle is judged at a front left side of the vehicle, a left side annunciation state is generated to inform the driver of the existence of the obstacle at the front left side of the vehicle by operating the vibration generator 10 placed at the left side while pausing an operation of the vibration generator 10 placed at the right side.

More specifically, based on a judgment on which side the obstacle appears, the right side annunciation state and the left side annunciation state are switched. In other words, the operations of the vibration generators are controlled. The annunciating device with such configuration can be applied in a condition of low visibility such as nighttime.

According to the first embodiment of the present invention, the linear type vibrating motor is adopted to the vibration generator 10. Further, the vibration generator 10 is arranged in such a manner that a direction of a reciprocating movement of the vibrator 13 is directed to the back and forth direction. Therefore, the vibration in the right and left direction can be reduced and the vibration in the back and forth direction can be increased. In other words, a directivity of the vibration in the right and left direction can be reduced and a directivity of the vibration in the back and forth direction can be increased. Further, an axis line on which the vibrator 13 is reciprocated (i.e., an axis line of the drive member 11 extending in the reciprocating direction) is not intersected with the pair of cushion frames 4. Therefore, the vibration of the vibrator 13 to be transmitted to each cushion frame 4 can be reduced without keeping the vibration generator 10 away from the cushion frame 4. Accordingly, the annunciating device according to the first embodiment of the present invention can reliably make the driver to feel the difference in level between the vibration from the right side and the vibration from the left side and the annunciating device can restrict generation of a sound.

Moreover, with the configuration of the annunciating device according to the first embodiment of the present invention, because the vibration generated by means of the vibration generator 10 is transmitted to the cushion member 3 to largely vibrate the cushion member 3 in the back and forth direction, a lack of transmission of the vibration to the driver can be restricted even in a condition where the driver's thighs are placed directly above the vibrator 13 but are not in contact with the seating surface.

A second embodiment of the present invention is explained hereinafter with reference to FIGS. 4-6. According to the second embodiment of the present invention, a rotation type vibrating motor is adopted to the vibration generator 20.

The vibration generator 20 includes an electrical motor 22 for rotary operating a rotational shaft 21 and includes a weight 23 serving as the vibrator assembled to an end portion of the rotational shaft 21. The rotation type vibrating motor includes a characteristic that vibration in a direction of rotational center of the weight 23 (a direction of Y-axis in FIG. 5) is at lower degree and vibration in directions perpendicular to the Y-axis (directions of Z-axis and X-axis) is at higher degree. In view of the above-mentioned characteristic, the vibration generator 20 according to the second embodiment of the present invention is arranged in such a manner that the Y-axis is directed to the right and left direction of the vehicle.

Accordingly, a directivity of the vibration in the right and left direction can be reduced and a directivity of the vibration in directions perpendicular to the right and left direction can be increased. Further, a surface of the weight 23 extending in a rotational radial direction thereof is not intersected with the pair of cushion frames 4. Therefore, the vibration of the vibrator 23 to be transmitted to each cushion frame 4 can be reduced without keeping the vibration generator 20 away from the cushion frame 4. Accordingly, the annunciating device according to the second embodiment of the present invention can reliably make the driver to feel the difference in level between the vibration from the right side and the vibration from the left side and the annunciating device can restrict generation of the sound.

Further, according to the second embodiment of the present invention, the vibration generator 20 is arranged in such a manner that each weight 23 is placed outside in the right and left direction relative to each electrical motor 22. In other words, the vibration generator 20 is arranged in such a manner that the position of the weight 23 relative to the center of the width of the seat 1 is farther than that of the motor 22 relative to the center of the width of the seat 1. Therefore, a distance between a part with a large vibration of the vibration generator 20 placed at the right side and a part with a large vibration of the vibration generator 20 placed at the left side can be broadened. Accordingly, the annunciating device according to the second embodiment of the present invention can reliably make the driver to feel the difference in level between the vibration from the right side and the vibration from the left side.

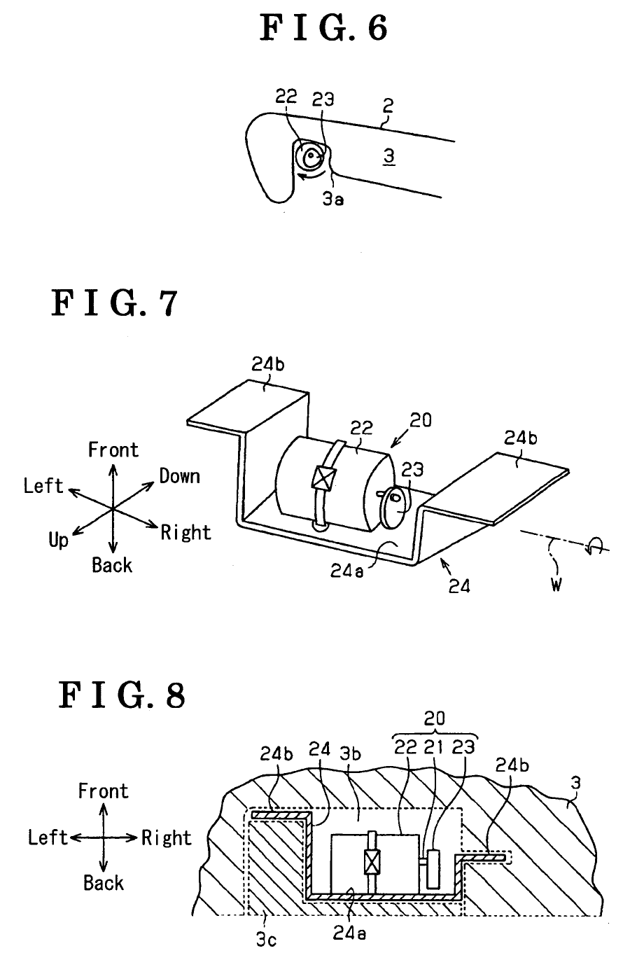

Because the structure of the annunciating device of the second embodiment of the present invention except for the structure of the vibration generator 20 is identical to that of the first embodiment of the present invention, numerals except for the vibration generator 20 in FIGS. 4 and 6 are identical to numerals of the first embodiment of the present invention. Further, the same structure as described in the first embodiment of the present invention is not repeatedly explained.

A third embodiment of the present invention is explained hereinafter with reference to FIGS. 7-8. The same structure as described in the aforementioned embodiments of the present invention is not repeatedly explained. According to the third embodiment of the present invention, as well as the second embodiment of the present invention, the rotation type vibrating motor is adopted to the vibration generator 20. Further, according to the third embodiment of the present invention, an assembling structure of the vibration generator 20 relative to the cushion member 3 includes the below mentioned characteristics. The vibration generator 20 is fixed to a bracket (i.e., supporter) 24 illustrated in FIG. 7. The bracket 24 is configured in such a way that rigidity in the back and forth direction is lower than rigidity in the up and down direction and the right and left direction to some degree.

More specifically, the bracket 24 made of a metal plate is formed substantially into a U-shape. The bracket 24 includes a concave portion 24a to which the vibration generator 20 is fixed and includes a flange portion 24b which is embedded and held in the cushion member 3. Because the bracket 24 is formed into a substantial U-shape, the bracket 24 is hardly elastically deformed about a longitudinal direction of the bracket 24 (a direction indicated by numeral W in FIG. 7) and the bracket 24 is easily elastically deformed in the back and forth direction of the bracket 24. Consequently, rigidity of the bracket 24 in the back and forth direction is lowered. The bracket 24 is arranged in such a manner that the longitudinal direction W of the bracket 24 is directed in the direction of rotational center of the weight 23. Accordingly, an increase of the vibration generated by means of the vibration generator 20 in the back and forth direction can be promoted.

Further, as illustrated in FIG. 8, a space 3b is provided between the vibration generator 20 and the cushion member 3 in the back and forth direction of the seat. Accordingly, increase of the vibration generated by means of the vibration generator 20 in the back and forth direction can be promoted.

Moreover, a part of the cushion member 3 (i.e., a first cushion member) facing a connecting portion of the bracket 24 for connecting the flange portion 24b with the concave portion 24a is made of a separated cushion member 3c (i.e., a second cushion member). Rigidity of the cushion member 3c is lower than rigidity of the cushion member 3 to some degree. Accordingly, lowering of the vibration generated by means of the vibration generator 20 in the right and left direction can be promoted. Therefore, the sound can be reduced.

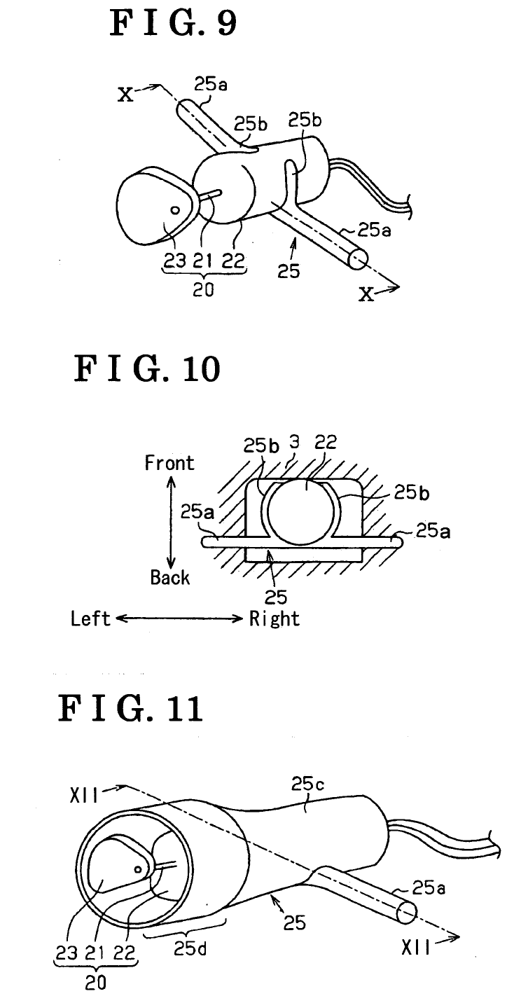

A fourth embodiment of the present invention is explained hereinafter with reference to FIGS. 9-10. The same structure as described in the aforementioned embodiments of the present invention is not repeatedly explained. According to the third embodiment of the present invention, the bracket 24 made of the metal plate is adopted as the supporter for supporting the vibration generator 20. In contrast, according to the fourth embodiment of the present invention, a supporter 25 made of resin is adopted as the supporter for supporting the vibration generator 20. As illustrated in FIG. 10, the supporter 25 includes a substantially columnar main body portion 25a extending in the right and left direction and includes a pair of holding portions 25b extending in the back and forth direction from the main body portion 25a. The main body portion 25a and the holding portion 25b are formed into a single member by means of resin.

The vibration generator 20 is held on the main body portion 25a of the supporter 25 by inserting the electrical motor 22 into the pair of holding portions 25b. Further, both ends of the main body portion 25a are embedded and held in the cushion member 3. The supporter 25 is arranged in such a manner that a longitudinal direction of the main body portion 25a is directed perpendicularly to the rotational center of the weight 23 (the direction of Y-axis in FIG. 5). Accordingly, the supporter 25 can be configured that rigidity in the back and forth direction is lower than rigidity in the up and down direction to some degree. In consequence, increase of the vibration generated by means of the vibration generator 20 in the back and forth direction can be promoted.

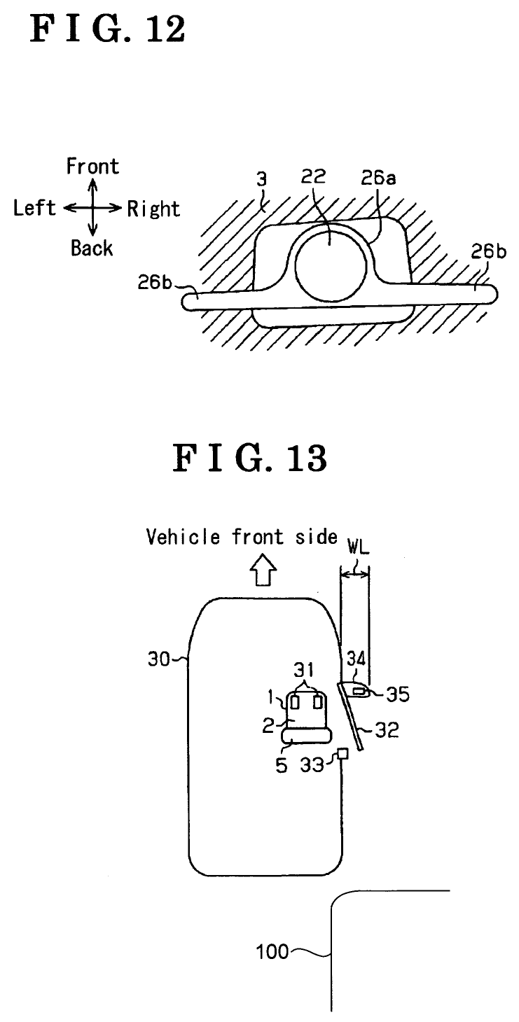

A fifth embodiment of the present invention is explained hereinafter with reference to FIGS. 11-12. The same structure as described in the aforementioned embodiments of the present invention is not repeatedly explained. According to the fourth embodiment of the present invention, the supporter 25 includes the pair of holding portions 25b extending in the back and forth direction to which the electrical motor 22 is inserted. In contrast, according to the fifth embodiment of the present invention, the supporter 25 includes a substantially cylindrical portion 25c instead of the holding portion 25b as illustrated in FIGS. 11 and 12. Further, the vibration generator 20 is inserted and held in the cylindrical portion 25c. Accordingly, the supporter 25 can be configured in such a way that rigidity in the back and forth direction is lower than rigidity in the up and down direction to some degree. In consequence, increase of the vibration generated by means of the vibration generator 20 in the back and forth direction can be promoted.

A protecting member 25d for covering a rotational locus of the weight 23 is provided at an end portion of the cylindrical portion 25c. Further, the protecting member 25d and the cylindrical portion 25c is formed into a single member. With the configuration of the protecting member 25d according to the fifth embodiment of the present invention, the weight 23 can be prevented from interfering with the cushion material 3 with an inexpensive and simple structure even in a condition where the cushion material 3 is bent because of the driver's weight.

A sixth embodiment of the present invention is explained hereinafter with reference to FIGS. 13-15. In the sixth embodiment of the present invention, the annunciating device according to first through fifth embodiments is applied to an alerting device for a vehicle for claiming an occupant's attention at the time of a door opening operation. As illustrated in FIG. 13, two vibration generators 31 are provided side by side at an interior part of a seat 1 of a driver's seat of a vehicle 30. The structure of the vibration generator 31 is identical to that of the vibration generator 10 or that of the vibration generator 20. The same structure as described in the aforementioned embodiments of the present invention is not repeatedly explained.

In the vicinity of a vehicle door 32 of the driver's seat, a door courtesy switch 33 (i.e., a door state detector) is provided for detecting opening and closing states of the door. Further, in a door mirror 34 provided at the vehicle door 32, a camera 35 (i.e., a backside detector) is embedded for monitoring a backward view. According to the sixth embodiment of the present invention, the vehicle door 32 is a swing door which opens toward the outside of the vehicle by making a hinge as a fulcrum.

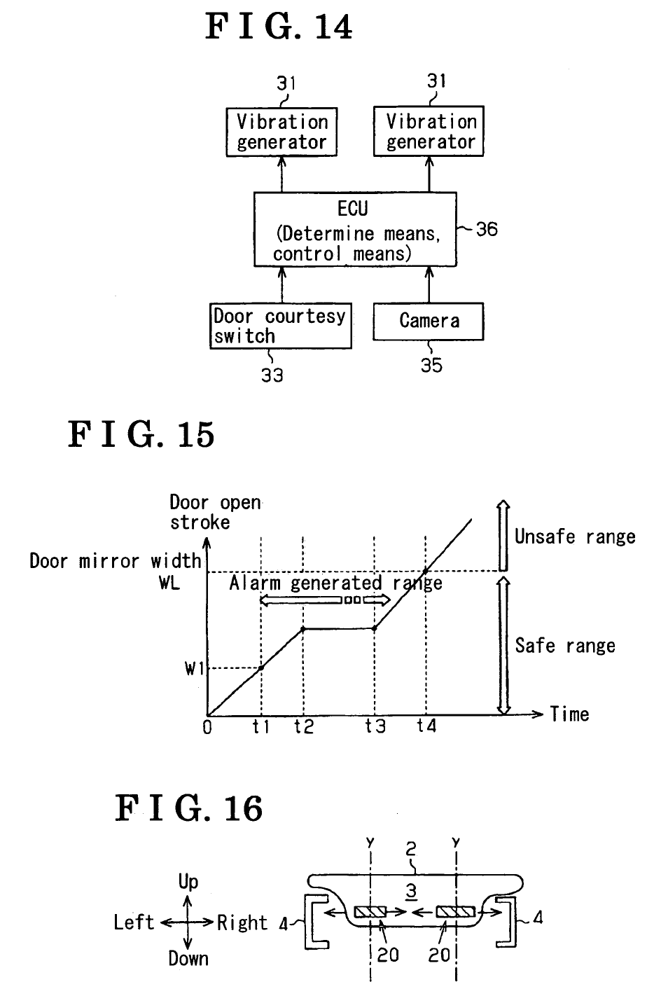

As illustrated in FIG. 14, an ECU 36 (i.e., an electronic control unit as a determining device and a controller) is electrically connected to the door courtesy switch 33, the camera 35, and the vibration generator 31. The ECU 30 which is mainly composed of a digital computer, inputs a detecting signal from the door courtesy switch 33 and the camera 35 and outputs an operating signal to each vibration generator 31.

For example, based on the detecting signal from the door courtesy switch 33, the ECU 36 detects the opening operation of the vehicle door 32 in a condition where the driver (the occupant) gets out of the vehicle. Further, by analyzing an image signal (an image data) from the camera 35, the ECU 36 detects whether an approaching vehicle 100 (an automobile, a two-wheel vehicle, or the like) from behind is approaching. When the approaching vehicle 100 from behind is detected in a condition where the vehicle door 32 is under opening operation, the ECU 36 (i.e., the determining device, the controller) determines to alert the occupant and operates the vibration generator 31 to vibrate by outputting the operation signal thereto. The driver then feels the vibration from the vibration generator 31. Accordingly, the alerting device according to the sixth embodiment of the present invention can claim the driver's attention at the time of the door opening operation of the vehicle door 32.

According to the sixth embodiment of the present invention, the ECU 36 outputs the operation signal to one of the vibration generators 31 placed at the vicinity of the vehicle door 32 for operating the vibration generator 31 placed at the vicinity of the vehicle door 32. Therefore, the driver feels the vibration from the vibration generator 31 placed in the vicinity of the vehicle door 32. Accordingly, the alerting device according to the sixth embodiment of the present invention can claim the driver's attention at the time of the door opening operation of the vehicle door 32.

Illustrated in FIG. 15 is a time chart indicating a stroke of the vehicle door 32 at the time of the door opening operation. The stroke of the vehicle door 32 represents an outwardly protruding range of the vehicle door 32 at the time of the door opening operation of the vehicle door 32. In FIG. 15, a point of releasing a lock of the vehicle door 32 represents an original point. Further, a time when the door courtesy switch 33 is switched from OFF to ON represents t1, a time when a state of the vehicle door 32 is completely shifted to a half-shut state represents t2, and a time when the vehicle door 32 is began to open by the driver pushing the vehicle door 32 represents t3. Moreover, according to the sixth embodiment of the present invention, a safe range of the stroke of the vehicle door 32 relative to the approaching vehicle is set within a range WL illustrated in FIG. 13, the range WL represents a protruding width of the door mirror 34. A time when the stroke of the vehicle door 32 reaches a higher limit of the range WL represents t4. More specifically, a period from t1 to t4 represents a condition in which the stroke of the vehicle door 32 is within the safe range.

With reference to FIG. 15, a shift to the half-shut state of the vehicle door 32 in accordance with the opening operation of the vehicle door 32 is completed later than the time t1 at which time the door courtesy switch 33 is turned ON (time t2). A pushing operation of the vehicle door 32 by the driver begins later than the time t2 (time t3). Therefore, when the stroke of the vehicle door 32 at the time of t1 is assumed to be W1, the alerting device can claims the occupant's attention well in advance if the vibration generator 31 began to operate from a time of the stroke W1 which is within the safe range. Termination of the operation of the vibration generator 31 may be automatically performed predetermined period after the time t1. Further, if a further opening operation of the vehicle door 32 from the half-shut state can be detected, the termination of the operation of the vibration generator 31 may be performed when the further opening operation of the vehicle door begins.

The annunciating device according to the aforementioned embodiments of the present invention is used as the annunciating device which informs the driver on which side an obstacle exists in a condition where the obstacle appears in front of the vehicle at the time of driving. However, use of the annunciating device is not limited thereto. Alternatively, or in addition, the annunciating device may be applied to the following uses. 1) The present invention may be used as an annunciating device or a clearance detecting and ranging apparatus which informs the driver of an obstacle located at the back of the vehicle at the time of parking the vehicle in a predetermined parking area. 2) The present invention may also be used as an annunciating device which informs the driver of approaching pedestrians or vehicles instead of an obstacle. 3) The present invention may be used as a dozing detecting and alarming apparatus which detects if the driver is fallen asleep and alerts the driver. 4) The present invention may be used as a lane deviation alarming apparatus which alerts the driver if the vehicle is deviating from a driving lane. 5) The present invention may be used as a stop alarming apparatus which alerts the driver if the driver does not stop at an area in which the vehicle should be stopped or alerts the driver that the vehicle will soon arrive the area in which the vehicle should be stopped. 6) The present invention may be used as a navigation annunciating device which performs a right side annunciation and a left side annunciation by means of the vibration generator 10, 20 in conjunction with an audio guidance in the back and forth direction and the right and left direction by means of a navigation apparatus.

According to the embodiments of the present invention, the vibration generator 10, 20, and 31 is provided at the interior part of the seating portion 2. However, the present invention is not limited thereto. Alternatively, or in addition, the vibration generators 10, 20, and 31 may be provided at an interior part of the seatback portion 5.

According to the embodiments of the present invention, the vibration generator 10, 20, and 31 is provided at the seat 1 of a driver's seat for informing the driver of a condition outside of the vehicle. However, the present invention is not limited thereto. Alternatively, or in addition, the vibration generator 10, 20 may be provided at any seat of the vehicle for informing the occupant of the condition outside of the vehicle.

According to the embodiments of the present invention, two vibration generators 10, 20, and 31 are arranged side by side. However, the present invention is not limited thereto. Alternatively, or in addition, a total of four vibration generators may be provided in such a manner to be arranged in the front and the rear as well as in the left and right sides. Further, alternatively, or in addition, a total of six vibration generators may be provided in such a manner to be arranged in two lines with three vibration generators.

According to the first through fifth embodiments of the present invention, in the right side annunciation state, the vibration generator 10 placed at the right side is operated while the operation of the vibration generator 10 placed at the left side has been paused. However, the present invention is not limited thereto. Alternatively, or in addition, in the right side annunciation state, the vibration generator 10 placed at the left side may be vibrated at a lower degree than the vibration generator 10 placed at the right side. The same is said of the left side annunciation state.

According to the sixth embodiment of the present invention, during an operation of the vibration generator 31 placed in the vicinity of the vehicle door 32 (the vibration generator 31 placed at the right side), the operation of the vibration generator 31 placed at the left side has been paused. However, the present invention is not limited thereto. Alternatively, or in addition, the vibration generator 31 placed at the left side may be vibrated at a lower degree than the vibration generator 31 placed at the right side.

According to the first embodiment of the present invention, each vibration generator 10 is arranged in such a manner that the direction of the reciprocating movement of the electrical motor 12 is directed to the back and forth direction. However, the present invention is not limited thereto. Alternatively or in addition, each vibration generator 10 may be arranged in such a manner that the direction of the reciprocating movement is directed to the up and down direction. Further, the direction of the reciprocating movement of the electrical motor does not have to be strictly corresponding with the back and forth direction or the up and down direction. The present invention is applicable as long as the axis line on which the vibrator 13 is reciprocated is not intersected with the pair of support frames 4. For example, the vibration generator 10 may be arranged in such a manner that the direction of the reciprocating movement of the electrical motor 12 is inclined in less than or equal to 45 degrees relative to the back and forth direction or the up and down direction.

According to the second embodiment of the present invention, each vibration generator 20 is arranged in such a manner that a direction of the rotational center of the weight 23 (the direction of Y-axis in FIG. 5) is directed to the right and left direction of the vehicle. However, the direction of Y-axis does not have to be strictly corresponding with the right and left direction. The present invention is applicable as long as the surface of the weight 23 extending in the rotational radial direction thereof is not intersected with the pair of support frames 4, 6. For example, the vibration generator 20 may be arranged in such a manner that the direction of Y-axis is inclined in less than or equal to 45 degrees relative to the right and left direction

According to the embodiments of the present invention, the vibration generator 10, 20, and 31 is provided at the interior part of the seat 1, the interior part being sandwiched by the pair of support frames 4, 6. However, the present invention is not limited thereto. The present invention is applicable as long as the vibration generator 10, 20, and 31 is arranged in such a manner that the axis line on which the vibrator 13 is reciprocated is not intersected with the pair of support frames 4 or the surface of the weight 23 extending in the rotational radial direction thereof is not intersected with the pair of support frames 4, 6. For example, the vibration generator 10, 20, and 31 may be provided in the seat 1 at outside of the pair of support frames 4, 6.

According to the embodiments of the present invention, in a condition where the vibration generator 10, 20, and 31 is provided at the interior part of the seating portion 2, the vibration generator 10, 20, and 31 is placed at the same level as the pair of support frames 4. However, the present invention is not limited thereto. The present invention is applicable as long as the vibration generator 10, 20, and 31 is arranged in such a manner that the axis line on which the vibrator 13 is reciprocated does not intersect with the pair of support frames 4 or the surface of the weight 23 extending in the rotational radial direction thereof does not intersect with the pair of support frames 4, 6. For example, the vibration generator 10, 20, and 31 may be placed higher than the support frame 4 or lower than the support frame 4.

According to the sixth embodiment of the present invention, the camera 35 is provided for monitoring the backward view. However, the present invention is not limited thereto. Alternatively, or in addition, the obstacle detecting apparatus such as the infrared radiation sensor, or the like, for monitoring the backward view may be provided instead of the camera 35.

The vibration generator which generates the vibration by reciprocating the vibrator includes a characteristic that a level of the vibration vector in the reciprocating direction of the vibrator is at a higher degree. According to claims 1-5 of the present invention, the vibration generator is adopted which generates the vibration by reciprocating the vibrator and the axis line on which the vibrator is reciprocated is prevented from intersecting with the pair of support frames. Therefore, the vibration of the vibrator to be transmitted to the pair of support frames can be reduced without keeping the vibration generator away from the pair of support frame. Accordingly, the annunciating device can reliably make the occupant feel the difference in level between the vibration from the right side and the vibration from the left side and the annunciating device can restrict the generation of the sound.

In a condition where the vibration generator is provided at the interior part of the seating portion as described in claims 2 and 7, the support frame represents the frame for supporting the seating portion (numeral 4 in FIG. 1). In contrast, in a condition where the vibration generator is provided at the interior part of the seatback portion as described in claims 4 and 11, the support frame represents the frame for supporting the seatback portion (numeral 9 in FIG. 1).

The vibration generator which generates the vibration by rotary operating the vibrator includes a characteristic that a level of the vibration vector in the rotational radial direction of the vibrator is at a higher degree. According to claims 6-16 of the present invention, the vibration generator is adopted which generates the vibration by rotary operating the vibrator and the surface of the vibrator extending in the rotational radial direction thereof is not intersected with the pair of support frames. Therefore, the vibration of the vibrator to be transmitted to the pair of support frames can be reduced without keeping the vibration generator away from the pair of support frames. Accordingly, the annunciating device can reliably make the occupant feel the difference in level between the vibration from the right side and the vibration from the left side and the annunciating device can restrict the generation of the sound.

According to various tests implemented by inventors, it is found that the occupant can readily be informed from which side the vibration is transmitted if the vibration vector in the back and forth direction is higher degree than the vibration vector in the up and down direction in a condition where the vibration generator is provided at the seating portion of the seat. More particularly, depending on the seating posture of the occupant, the part of the occupant's thighs may be placed directly above the vibrator but may not be contacted with the seating surface of the seat as illustrated in FIG. 3 (the space L may be left between the part of the occupant's thighs and the seating surface of the seat). In such circumstances, if the vibration generator is provided in such a manner that the vibration vector in the up and down direction is higher degree than the vibration vector in the back and forth direction, degree of the vibration to be transmitted to the occupant is lowered.

According to claims 3 and 10 of the present invention, because a level of the vibration vector in the back and forth direction is at a higher degree, lowering of the vibration transmitted to the occupant can be restricted even in a condition where the occupant's thighs are placed directly above the vibrator but is not in contact with the seating surface of the seat. Accordingly, the annunciating device can reliably make the occupant feel the difference in level between the vibration from the right side and the vibration from the left side and the annunciating device can restrict the generation of the sound.

Further, according to various tests implemented by inventors, it is found that the occupant can readily be informed from which side the vibration is transmitted if the vibration vector in the up and down direction is higher degree than the vibration vector in the back and forth direction in a condition where the vibration generator is provided at the seatback portion of the seat. More particularly, depending on the seating posture of the occupant, the part of the occupant's back may be placed directly in front of the vibrator but may not be in contact with the seatback portion of the seat. In such circumstances, if the vibration generator is provided in such a manner that the vibration vector in the back and forth direction is higher degree than the vibration vector in the up and down direction, degree of the vibration to be transmitted to the occupant is lowered.

According to claims 5 and 14 of the present invention, because a level of the vibration vector in the up and down direction is at a higher degree, lowering of the vibration transmitted to the occupant can be restricted even in a condition where the occupant's back is placed directly in front of the vibrator but is not in contact with the seatback portion of the seat. Accordingly, the annunciating device can reliably make the occupant feel the difference in level between the vibration from the right side and the vibration from the left side and the annunciating device can therefore restrict the generation of the sound.

Further, according to claims 9 and 14 of the present invention, a level of the vibration vector in the right and left direction becomes lower. Therefore, the generation of sound can be restricted. With the configuration of the vibration generator which generates the vibration by rotary operating the vibrator, the whole vibration generator is vibrated. This type of vibration generator includes a characteristic that a level of the vibration of the vibrator of the vibration generator becomes especially higher. In view of the above-mentioned characteristic, the annunciating device according to claim 17 of the present invention can reliably make the occupant feel the difference in level between the vibration from the right side and the vibration from the left side because the distance between the part with the large vibration of the vibration generator placed at the right side and the part with the large vibration of the vibration generator placed at the left side can be broadened.

According to claim 18 of the present invention, by means of the door state detector and the backside detector, an existence of the approaching vehicle (the automobile, the two-wheel vehicle, or the like) from behind is detected in a condition where the driver (the occupant) gets out of the vehicle. Further, on the basis of a result detected by means of the door state detector and the backside detector, when the determining device determines to alert the occupant, the vibration generator is operated by controlling the annunciating device by the controller. Accordingly, the alerting device can claim the driver's attention at the time of the door opening operation of the vehicle door.

According to claim 19 of the present invention, the occupant feels the vibration from the vibration generator placed in the vicinity of the vehicle door. Accordingly, the alerting device can claim the driver's attention at the time of the door opening operation of the vehicle door.

The principles, preferred embodiment and mode of operation of the present invention have been described in the foregoing specification. However, the invention which is intended to be protected is not to be construed as limited to the particular embodiment disclosed. Further, the embodiment described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. An annunciating device for a vehicle comprising:
a seat;
a pair of support frames provided at both sides of the seat and extending in a back and forth direction or in an up and down direction of the seat; and
at least two vibration generators provided side by side at an interior part of the seat for generating a vibration by reciprocating a vibrator, an operation of one of the vibration generators or both of the vibration generators being controlled, wherein the vibrator reciprocates on an axis line which does not intersect with the support frame.

2. The annunciating device for a vehicle according to claim 1, wherein the vibration generator and the pair of support frames are provided at a seating portion of the seat.

3. The annunciating device for a vehicle according to claim 2, wherein the vibrator reciprocates on the axis line which is directed to the back and forth direction of the seat.

4. The annunciating device for a vehicle according to claim 1, wherein the vibration generator and the pair of support frames are provided at a seatback portion of the seat.

5. The annunciating device for a vehicle according to claim 4, wherein the vibrator reciprocates on the axis line which is directed to the up and down direction of the seat.

6. An annunciating device for a vehicle comprising:
a seat;
a pair of support frames provided at both sides of the seat and extending in a back and forth direction or in an up and down direction of the seat; and
at least two vibration generators provided side by side at an interior part of the seat for generating a vibration by rotary operating a vibrator, an operation of one of the vibration generators or both of the vibration generators being controlled, wherein a surface of the vibrator extending in a rotational radial direction thereof does not intersect with the support frame.

7. The annunciating device for a vehicle according to claim 6, wherein the vibration generator and the pair of support frames are provided at a seating portion of the seat.

8. The annunciating device for a vehicle according to claim 7, wherein the vibration generator includes an electrical motor for rotating the vibrator and a supporter for supporting the electrical motor.

9. The annunciating device for a vehicle according to claim 8, wherein rigidity of the supporter in a right and left direction of the seat is higher degree than rigidity of the supporter in the back and forth direction and the up and down direction of the seat.

10. The annunciating device for a vehicle according to claim 8, wherein rigidity of the supporter in the up and down direction of the seat is higher degree than rigidity of the supporter in the back and forth direction of the seat.

11. The annunciating device for a vehicle according to claim 9, wherein rigidity of the supporter in the up and down direction of the seat is higher degree than rigidity of the supporter in the back and forth direction of the seat.

12. The annunciating device for a vehicle according to claim 6, wherein the vibration generator and the pair of support frames are provided at a seatback portion of the seat.

13. The annunciating device for a vehicle according to claim 12, wherein the vibration generator includes an electrical motor for rotating the vibrator and a supporter for supporting the electrical motor.

14. The annunciating device for a vehicle according to claim 13, wherein rigidity of the supporter in a right and left direction of the vehicle is higher degree than rigidity of the supporter in a back and forth direction and an up and down direction of the vehicle.

15. The annunciating device for a vehicle according to claim 13, wherein rigidity of the supporter in a back and forth direction of the vehicle is higher degree than rigidity of the supporter in an up and down direction of the vehicle.

16. The annunciating device for a vehicle according to claim 14, wherein rigidity of the supporter in a back and forth direction of the vehicle is higher degree than rigidity of the supporter in an up and down direction of the vehicle.

17. The annunciating device for a vehicle according to claim 6, wherein the vibration generator is provided in such a manner that the vibrator of the vibration generator is placed outside in a right and left direction of the seat relative to the electrical motor of the vibration generator.

18. An alerting device for a vehicle including the annunciating device for a vehicle according to claim 1 comprising:
a door state detector for detecting opening and closing states of a vehicle door;
a backside detector for detecting an approaching vehicle from behind;
a determining device for determining whether to alert on the basis of a result detected by the door state detector and the backside detector; and
a controller for controlling the annunciating device on the basis of a result determined by the determining device.

19. The alerting device for a vehicle according to claim 18, wherein the controller controls the annunciating device to operate the vibration generator which is placed in the vicinity of the vehicle door of the vibration generators when the determining device determines to alert.

20. An annunciating device for a vehicle comprising:
a seat;
a support frame provided at the seat and extending in a back and forth direction or in an up and down direction of the seat; and
a vibration generator provided at an interior part of the seat for generating a vibration by reciprocating a vibrator or by rotary operating a vibrator, wherein a direction of a reciprocating operation of the vibrator or a surface of the vibrator extending in a rotational radial direction thereof does not intersect with the support frame.
